(19) United States
(12) Patent Application Publication
(10) Pub. No.: US 2025/0362376 A1
(43) Pub. Date: Nov. 27, 2025

(54) METHOD AND APPARATUS FOR MULTI-STATIC RADAR OPERATIONS IN A WIRELESS COMMUNICATION NETWORK

(71) Applicant: Telefonaktiebolaget LM Ericsson (publ), Stockholm (SE)

(72) Inventors: Henrik SJÖLAND, LUND (SE); Magnus SANDGREN, STAFFANSTORP (SE); Gang ZOU, LUND (SE); Andres REIAL, HÖLLVIKEN (SE); Ashkan KALANTARI, MALMÖ (SE); Rickard LJUNG, HELSINGBORG (SE)

(21) Appl. No.: 18/873,712

(22) PCT Filed: Jul. 7, 2022
(86) PCT No.: PCT/EP2022/069002

§ 371 Date: Dec. 10, 2024

(51) Int. Cl. G01S 7/00; G01S 13/00; G01S 13/86

(52) U.S. Cl. CPC G01S 7/006; G01S 13/003; G01S 13/86

(57) ABSTRACT

A wireless communication network performs multi-static radar operations, including operating multiple access points as geographically-diverse radar transmitters that transmit illumination signals, for illumination of a target region, and an example User Equipment (UE) operates as a radar receiver with respect to the multi-static radar transmission. The network may perform multi-static radar operations on demand, for power savings and interference reduction, and UEs may indicate particular radar-sensing needs or capabilities when requesting multi-static radar operation, for consideration by the network when configuring the corresponding illumination-signal transmissions.

### TECHNICAL FIELD

Various aspects of multi-static radar operations in a wireless communication network are disclosed herein.

### BACKGROUND

A “User Equipment” or UE refers to a wireless communication device that is associated with one or more applications using the device to consume one or more communication services provided by or through a wireless communication network, such as a cellular network based on Third Generation Partnership Project (3GPP) specifications. Some types of UEs provide personal communication services and media consumption, such as smartphones or tablets or computers that have cellular or other network modems included therein. Other types of UEs are embedded, such as in sensing or control systems that rely on wireless connections for data and control communications, or in vehicular systems where the UEs provide connectivity for various communication, control, or safety applications.

As radio frequencies used for wireless communications extend upward into the frequency ranges suitable for radar operations, new opportunities exist for radar sensing using communication resources associated with wireless communications. As used herein, the term “communication resource” refers, at a minimum, to a particular frequency or frequency range. However, depending upon the type of wireless communication network involved, the term may connote further resource distinctions that are used to distinguish individual transmissions of control signaling or data within the network. Examples include any one or more of time resources, codes, sequences, spatial directions, or spatial layers.

UEs may be involved in radar sensing for various reasons, depending upon the nature of the UE or its related application(s) or the equipment with which it is associated. For example, an automobile or other vehicle may include an embedded UE that performs radar sensing for environmental awareness or obstacle detection as part of autonomous navigation or vehicle safety. As another example, a UE used for mobile broadband communications may employ radar sensing to detect its proximate environment and adjust the directional properties of its transmitter or receiver to avoid directions that it senses as blocked. Such involvements may be initiated from a device perspective or from a network perspective.

Multiple challenges arise with respect to the incorporation or radar-sensing operations into the operational context of wireless communication networks, in terms of balancing radar-sensing needs with communications needs. Introducing radar operation in a given frequency band used by a wireless communication network risks interference with communication signals at frequencies in or nearby the frequency band and reduces the number or amount of resources in that frequency band that are available for communications. Additional complications arise with respect to managing potentially high densities of radar UEs. Further challenges exist in the context of radar sensing, in that UEs often are physically compact devices, meaning that in-device interference is a problem with respect to the full-duplex transmission of radar signals and corresponding reception of return reflections.

### SUMMARY

A wireless communication network performs multi-static radar operations, including operating multiple access points as geographically-diverse radar transmitters that transmit illumination signals, for illumination of a target region, and an example User Equipment (UE) operates as a radar receiver with respect to the multi-static radar transmission. The network may perform multi-static radar operations on demand, for power savings and interference reduction, and UEs may indicate particular radar-sensing needs or capabilities when requesting multi-static radar operation, for consideration by the network when configuring the corresponding illumination-signal transmissions.

One embodiment comprises a method of operation in a wireless communication network, where the method includes transmitting configuration information for a UE from a network node in the wireless communication network. The configuration information indicates a multi-static radar configuration in which the UE acts a radar receiver and a set of access points in the wireless communication network act as radar transmitters, transmitting respective illumination signals for illumination of a target region.

A related embodiment comprises a network node that is configured for operation in a wireless communication network, where the network node includes communication interface circuitry and processing circuitry. The processing circuitry is configured to transmit, via the communication interface circuitry, configuration information for a UE, where the configuration information indicates a multi-static radar configuration in which the UE acts a radar receiver and a set of access points in the wireless communication network act as radar transmitters, transmitting respective illumination signals for illumination of a target region.

Another embodiment comprises a method performed by a UE configured for operation with a wireless communication network. The method includes the UE receiving configuration information indicating a multi-static radar configuration for illumination of a target region via the transmission of illumination signals by a set of access points of the wireless communication network. Each access point acts as a respective radar transmitter in the multi-static radar configuration and the UE acts as a radar receiver in the multi-static radar configuration. The method further includes the UE receiving the illumination signals from at least two different access points in the set of access points, according to the configuration information, and performing at least one of object detection or self-positioning, based on the received illumination signals.

A related embodiment comprises a UE configured for operation with a wireless communication network, with the UE radio transceiver circuitry and processing circuitry. The processing circuitry is configured to: receive, via the radio transceiver circuitry, configuration information indicating a multi-static radar configuration for illumination of a target region via the transmission of illumination signals by a set of access points of the wireless communication network, each access point acting as a respective radar transmitter in the multi-static radar configuration and the UE acting as a radar receiver in the multi-static radar configuration; receive, via the radio transceiver circuitry, the illumination signals from at least two different access points in the set of access points, according to the configuration information; and perform at least one of object detection or self-positioning, based on the received illumination signals.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network and associated user equipments (UEs) according to one embodiment.

FIG. 2 is a block diagram of example details for the wireless communication network of FIG. 1.

FIG. 3 is a block diagram of an example arrangement of beamforming, for illumination of a target area.

FIGS. 4 and 5 are block diagrams of access points and a UE, with respect to example transmissions of illumination signals.

FIG. 6 is a block diagram of a network node and a UE, according to example embodiments.

FIG. 7 is a block diagram of example details of processing circuitry of the network node introduced in FIG. 6.

FIG. 8 is a logic flow diagram of a method of operation by a network node for multi-static radar operation, according to one embodiment.

FIG. 9 is a block diagram of a network node, according to another embodiment.

FIG. 10 is a block diagram of an access point of a wireless communication network, according to one embodiment.

FIG. 11 is a block diagram of example details of processing circuitry of the UE introduced in FIG. 6.

FIG. 12 is a block diagram of a method of operation by a UE for multi-static radar operation, according to one embodiment.

FIG. 13 is a block diagram of a UE, according to another embodiment.

### DETAILED DESCRIPTION

In the context of this disclosure, the phrase “multi-static radar operation” refers to two or more access points of a wireless communication network acting in coordinated fashion as radar transmitters with respect to a given User Equipment (UE) acting as a radar receiver. Correspondingly, the term “UE” refers to essentially any type of end-user equipment that wirelessly connects to the network for the consumption of services provided by or through the network, with “services” referring to communication services, location services, radar services, or any combination of communication, location, and radar services. “Access points” are essentially any type of Transmit Reception Point (TRP) for transmission, repetition, or reflection of radio signals, that provides radio connectivity on behalf of the network, such as base stations, whether integrated or distributed. Such access points may sometimes be referred to as gNBs or eNBs in certain types of wireless communication systems.

Continuing with operative definitions, the term “multi-static radar event” refers to a particular occasion of multi-static radar operation by the network, with each such occasion involving the transmission of radar signals by particular access points, for the benefit of one or more particular UEs acting as the radar receivers. A “radar signal” may be a normal communication signal of the network, such as a synchronization signal or other reference signal, although use of the communication signal for radar may involve additional transmissions or transmissions at times not used specifically for communication purposes.

Radar signals also may be dedicated for radar operations, such as using one or more transmission parameters not used for “normal” communication signals. Such parameters include any one or more of signal frequencies, signal bandwidths, beamforming configurations, encodings, identifiers, transmit bit sequences or timing. However, with the term “communication resources” referring at a minimum to frequency, radar signals in one or more embodiments disclosed herein reuse communication resources of the network, meaning that the network coordinates its multi-static radar operations in the context of ongoing communications operations, to avoid interference by, between, or among UEs using radar services or communication services or both.

Each multi-static radar event involves the illumination of a target region, meaning that the radar signals transmitted by the participating access stations are directed towards the target region, or otherwise result in the target region being “illuminated” with electromagnetic signal energy that can be detected by a UE directly via Line-of-Sight (LoS) paths, or indirectly via Non-LoS paths involving signal reflections. As such, the radar signals may also be referred to as “illumination signals”, where the term broadly refers to signals for generating radar reflections that can be detected over an area of interest. Generally, the UE(s) acting as radar receivers during a given multi-static radar event are located in or are proximate to the target region. Although the target region may be defined in free-space, such as may be relevant for drones or other aerial UEs, given target regions may comprise or include a terrestrial footprint, i.e., a ground area to be illuminated by the transmitted radar signals.

Target regions may be predefined or otherwise coincide with divisions used by the network for communication-signal coverage. For example, the target region selected for illumination during a given multi-static radar event may be a service area, such as a particular “cell” or “sector” or “beam” or “beam coverage area” of the network that is defined with respect to the transmission or reception of communication signals. Thus, different target regions in one or more embodiments are identified or indicated using cell identifiers, sector identifiers, beam identifiers, or other identifiers used in the network to identify defined network coverage areas. Target regions may also be defined in terms of geographic coordinates. In at least one embodiment, the network determines the target region to illuminate based on the location(s) of the UE(s) that will act as radar receivers with respect to a multi-static transmission, e.g., it may select as the target region one or more service areas of the network that include and/or are adjacent to the UE(s). In other embodiments, a UE indicates the target region, such as by indicating geographic coordinates, or by indicating the service area(s) to be illuminated. Service area(s) are identified, for example, using network cell IDs, sector IDs, beam IDs, etc.

The wireless communication network in question may be a Fifth Generation (5G) New Radio (NR) network in accordance with the technical specification promulgated by the Third Generation Partnership Project (3GPP) or otherwise may use carrier frequencies in a frequency range that is suitable for radar sensing. It is advantageous for the radar signals to have transmission parameters, e.g., frequencies, bandwidths, encodings, powers, beam shapes, etc., that are within the capabilities of the radio equipment and antenna systems used by the access points for transmission and reception of communication signals, so that the same radio equipment and antenna systems can be reused for the transmission of radar signals.

In one or more embodiments, the network realizes significant power savings by providing radar services on a demand basis, e.g., in response to an indication of a need for radar service such as requests incoming from respective UEs. Because the radar signals reuse “communication resources” of the network in one or more embodiments, where the term “communication resources” at a minimum refers to frequencies in the electromagnetic spectrum or, in an OFDM system, resource blocks in the time-frequency resource grid, the network coordinates radar services and communication services. Here, referring to the “network” as performing certain actions shall be understood as referring to a particular network node or a particular collection of network nodes performing such actions.

In an example embodiment or scenario, an access point of the network that is serving a given UE receives a request for multi-static radar operation by the network, and the network determines a “multi-static radar configuration” and initiates a multi-static radar event according to the multi-static radar configuration. At a minimum, the multi-static radar configuration defines which access points act as radar transmitters for the multi-static radar event. The multi-static radar configuration may further define particulars of the event, such as defining one or more of the transmission parameters of the radar signals, specifying the target region, etc. In an example embodiment, the network determines the multi-static configuration in dependence on the location of the requesting UE, which may be expressed in terms of the involved target region, or which may be used to identify the target region. Access points selected for participation in the multi-static radar event must have an LoS path to the target region in order for the radar functionality to get good performance, since the time of arrival for radar signal reflections will be used for determining characteristics of the detections from the radar—i.e., to reach good performance each access point must have a LOS path to at least a sub-region of the target region, such that its signal directly illuminates the target region or a sub-region therein.

Different types of signals can be transmitted for radar operations, such as wideband signals for high time resolution, and narrowband signals for low-power signal processing at the involved UE(s). The signals can be transmitted from different access points concurrently or sequentially. The signals can be transmitted in narrow beams, or in wide beams, or even omni-directionally, and multiple concurrent narrow beams can be transmitted from a given access point. Different codes may be assigned to different access points, and the access points in one or more embodiments may apply different codes, dependent on beam direction. Such an arrangement allows a receiving UE to distinguish radar signals received from different access points and distinguish radar signals transmitted in different beam directions by the same access point.

Multi-static radar operation of the network may be based on subscriptions, such that UEs not subscribed to radar services either cannot access the radar services or are provided with only a “base” level of radar service. For example, subscribing UEs are allowed to request specific multi-static radar configurations, or at least indicate performance requirements that inform how the network configures its corresponding multi-static radar operations. The UEs subscribing to the service can then receive the radar signals and their echoes due to surrounding objects and correlate for different codes of the access points and beam directions. Different subscription levels may provide different levels of accuracy—e.g., position information provided to UEs regarding the locations of the access points participating in a multi-static radar transmission may be specified at different resolutions or accuracies for different subscription levels. UEs with sufficient battery energy and accurately determined positions can also participate in the transmissions to improve the system coverage and performance. The UEs can use beamforming to receive signals from different directions to form a radar image. With digital beamforming multiple directions can be received and analyzed simultaneously, speeding up the process.

When narrow-band signals are received, substantial power can be saved in the signal reception/processing because of the reduced correlation size and search space. The resolution in time domain is then, however, limited. The precision of the radar measurements by the UE is then dependent on narrow radar beam widths, which is especially suitable for larger antenna arrays. The reduced time domain resolution of narrowband signals together with narrow beam widths limits the need for accurate time synchronization, and the fact that the location of objects can be found by joining the direction from the radar receiver and the directions from the transmitters.

Over the air (OTA) synchronization between a UE and an access point can either use a direct LoS path and compensate for one way delay, e.g., derived through positioning data anyway needed for multi static radar operation, or using a Round Trip Time (RTT) based method that does not require LoS. The former involves fewer steps and does not require information exchange of internal relative receive-transmit timing, such as required in the RTT based method, and in many cases, it can be assumed more accurate (but less flexible since requires LoS). If a LoS path does not exists and RTT based synchronization is not sufficiently accurate or for other reasons not supported, one option together with narrow band width time domain resolution limitations is using spatial domain and data from narrow beam widths. Worth noting, however, even if there is no LoS path between the UE and one of the access points, the UE can derive synchronization towards that access point based on synchronization towards another access point to which it has an LoS path. Such operations assume that the two access points are synchronized with sufficient accuracy.

Evaluating LoS presence between a UE and respective access points may use positioning data and knowledge about the environment, or any of comparing the above mentioned LoS-based and RTT-based OTA synchronizations, comparing RTT-based OTA synchronizations towards known positions (RF delay derived from RTT method and compared with physical LOS distance based on position data), comparing synchronization towards different access points that are well synchronized, or comparing object position using radar data derived from different combinations of multiple access points. In addition to time-based synchronization, for detection and estimates of velocity for moving objects, RF carrier phase changes over time can be used, but such use requires RF phase stability between the access points and the UE (with compensation for mobility of the UE, assuming fixed access points), such phase stability could be based on OTA synchronization methods where the UE (normally having less expensive and stable oscillators) can use the LoS direct RF path from an access point as a relative reference. A stable non-LoS path from a reflection off a stationary object also can be used as a relative reference.

The general principles of multi-static radar operation involve multiple radar signal transmissions, i.e., illumination by multiple transmitters at different locations. As one example multiple base stations may illuminate an area with transmissions of signals which may be used for radar functionality, e.g., based on individual UEs receiving and analyzing corresponding signal reflections. A UE receiving a reflected radar signal can utilize location information, such as the location of the radar signal transmitter and the location of the UE, to determine characteristics of the object reflecting the signal. Reception of reflected signals from one transmitter provides limited characteristics determination capabilities, while multiple transmitters allow for reflections from different angles, and thereby provides the UE with more and complementary information regarding the reflected object. The UE may process details from the detected radar signal(s), such as angle of reception, time of arrival, amplitude, phase, etc., to characterize the object location, shape, etc.

However, in a scenario where a UE uses the received radar signals for self-positioning—i.e., determining its location—it is valuable to have LoS paths between the UE and two or more of the access points participating in the multi-static radar event, because the location of the UE can then be determined by the angle of arrival of the radar signals at the UE. If the signals are not LoS simultaneously, they could be received by the UE at different locations where LoS to an access point is available, with an Inertial Measurement Unit (IMU) of the UE used to estimate the spatial relationship between the points of reception, and the UE position is then estimated based on knowing the movement of the UE between the times at which it received different radar signal transmission on LoS paths.

As an alternative in the context of self-positioning, if the UE has LoS to at least one of the access points participating in the multi-static radar transmission, the UE can combine ranging from a RTT-based method towards the single access point with spatial information gleaned from its beamforming capabilities.

Regarding narrowband or wideband illumination signals, if the signal correlation at the UE has the same length in time, the coverage provided will be the same for narrowband and wideband illumination signals. However, the correlator size is proportional to the signal bandwidth, and hence, as mentioned, the use of wideband illumination signals results in higher power consumption and larger search spaces from the perspective of the UE. Use of wideband signals as the transmitted radar signals, however, has the advantage of providing high resolution in the time domain, for distance sensing and self-locating. Thus, a given multi-static configuration used by the network may be based on wideband radar signals either as a complement to one or more narrowband radar signals, or instead of narrowband radar signals. Wideband radar signals transmitted to or received from a UE on LoS paths provide for accurate self-positioning, based on measuring signal propagation time or difference in propagation time. Again, assuming that a UE receives multiple wideband radar signals on LoS paths at different times, the UE may reconcile those receptions for distance/location calculations based on using its IMU to determine its movement between the respective reception events.

By measuring at least two radar signals transmitted by the network, the clock stability of the UE is not critical, as only a relative time difference of the two signals needs to be measured. For timing-based positioning of the UE, however, the participating access points must be well synchronized, either through LoS measurements using the radar signals together with LoS propagation delay or based on non-LoS transmission/receptions with Round Trip Time (RTT) determinations made using radio interface-based synchronization (RIBS). Satellites can also be used to obtain synchronization among the participating access points, and combinations of such techniques are used in one or more embodiments. For multi-static radar operation using time domain information, the radar transmitters and receiver(s) must be synchronized accurately, and the same methods as mentioned for positioning can be used.

The access points may transmit signals concurrently or sequentially. Concurrent transmission is beneficial as the number of resources used is minimized, but on the other hand weaker signals may be masked by stronger signals at the receiving UE(s). Sequential transmissions use more resources, but reduce the problem of weak signals being masked, and allow non-transmitting access points to receive the radar signals for use in synchronization and multi-static radar measurements. In a sequential scheme, the access points may transmit with well-known time relations, and the receiving UE(s) may take those time relations into account when analyzing the received radar signals, for self-positioning or object detection.

Another advantage of imbuing a wireless communication network with multi-static radar capabilities is that UEs can perform radar sensing, e.g., for object detection, without having to expend power for radar-signal transmission. It is also possible for low power devices to focus on the reception of the narrow-band radar signals to save power. Furthermore, by not transmitting radar signals, the UEs will not cause interference to each other or to other non-radar UEs and resource scheduling/coordination will be easier and can be fully autonomous at the NW. Multiple UEs can make use of same transmitted radar signals from the NW. Furthermore, the radar functionality does not require full duplex transceiver operations at either the UE side or the network side.

The network can transmit radar signals at different frequency bands, where lower mm-wave frequency bands or mid-band frequencies can be used to increase coverage, while higher frequencies can provide more bandwidth and more narrow beams for higher accuracy and resolution. For any given access point, the radar signal transmission can dynamically alter between narrow-band and wideband, and between concurrent and sequential transmissions, and between sweeping beams and wide illumination, etc. UEs subscribing to a radar service provided by the network can request the necessary information for using the service from the network.

Various advantages are associated with multi-static radar operation by a wireless communication network, according to the embodiments disclosed herein. Example advantages include: minimum of coordination required, access points may transmit in repetitive patterns; signals transmitted for radar sensing may be used for access-point/UE time synchronization; signals transmitted for radar sensing may be used for object detection and for self-positioning by UEs; UEs need not transmit radar signals; control by the network of radar signal transmissions makes management or avoidance of radar-to-radar and radar-to-communication interference straightforward; the approach complements the trend of increasing deployment densities for access points; the approach eliminates the need for full-duplex radar transceivers; allows for UEs to receive radar signals from objects illuminated from different directions or illumination angles, which increases the likelihood of object detection; the number of access points used as radar transmitters in any given multi-static radar event may be based on actual needs and performance gains; radar signals may be low bandwidth because high bandwidth and tight transmitter/receiver timing synchronization is not needed, given that sharp beams in the multi-static spatial domain enable high angular resolution; high bandwidth radar signals for time-domain based multi-static radar operation may be used when accurate transmitter/receiver synchronization is available, or spatial and time-domain based multi-static radar operations may be combined for enhanced radar performance and clutter rejection.

Further examples of advantages include any one or more of the following: UEs may use IMUs to track their changing locations with respect to reception of radar signals at different times, thus reducing the requirement for the UE receiving radar signals simultaneously on two or more LoS paths; with narrow beam directions used for the radar signals, LoS is not required between a UE and the transmitting access nodes, so long as the position and orientation of the UE is accurately known and there are LoS paths between the access nodes and an object to be detected, and between the object and the UE; different modes of operation are possible, e.g., both concurrent transmissions of radar signals by the access points to save resources, and sequential transmissions of the radar signals to support inter-access-point synchronization and radar reception; the ability to distinguish radar signals transmitted by different access points and in different directional beams using different codes or other identifiers, such that receiving UEs can readily distinguish the different radar signals; and the ability to transmit radar signals according to beam patterns that include wide beams or narrow beams or both, multiple beams, rotating beam sweeps, etc., and wherein the network can provide UEs with information about such transmission parameters to facilitate reception and processing of the radar signals by the UEs without further coordination.

In the context of this disclosure, “spatial-based” or “spatial domain” radar operations refer to use at the UE of concurrent radar signals from different directions/beams, which are evaluated in combination to characterize objects based on analyzing the signal reflections. Time based bi-static/multi-static radar refers to using the time domain information to derive object location. The time information contains the sum of the time-of-flight between transmitter and object and then from object to receiver (by measuring time). The time information contains the sum of the two subcomponents and forms a range ellipse with respect to known location of the transmitter and receiver where all locations fulfill the total time-of-flight (with different unknown values of the subcomponents). That is, the object may be at any place on the range ellipse defined by the total time-of-flight. To resolve the ambiguity, more transmitting nodes will be needed (or spatial information to point at a certain place on the range ellipse). With multiple transmit nodes there will be multiple range ellipses and the crossing of the range ellipses resolves the object location ambiguity. In at least one embodiment, a UE combines spatial domain and time domain evaluations, for improved radar performance.

To demonstrate the feasibility of multi-static radar operation in a wireless communication network, consider a couple of numerical examples, based on 100 GHz radar signals and 30 GHz radar signals, with these examples demonstrating that multi-static radar operations by a wireless communication network yield radar-sensing results at frequencies valid for both 5G and Sixth Generation (6G) wireless communication networks. First, calculation of the link budget demonstrates whether the transmit power is sufficient to illuminate all directions simultaneously, and still achieve sufficient radar range performance in UEs using the transmitted radar signals. Another aspect of the evaluation investigates the achievable beam widths, and what precision could be achieved relying on such beams for radar imaging.

Assume a UE with 100 antenna elements per panel, and access points with 2000 antenna elements spread over the panels, operating at 100 GHz center frequency, and assume a 14 dB total noise figure at the receiver of a UE acting as the radar receiver. Still further, assume a 5 dBm output power at each access-point antenna, i.e., 38 dBm total radiated power, which may be assumed as omnidirectional for simplicity, in which case the EIRP is also 38 dBm. Finally, for an assumed radar pulse length of 10 us, and an integration time of the same length, the received radar signal noise becomes

$$- 1 \; 74 dBm + NF - 10 log ( integration time ) = - 174 + 14 + 50 = - 1 \; 10 dBm .$$

The equation

$${P}_{r e c e ived} = {P}_{T X} + {G}_{T Xant} + {G}_{R Xant} + 10 log [ \frac{{λ}^{2} \cdot σ}{{( 4 π )}^{3} \cdot {R}_{Rx}^{2} {R}_{Tx}^{2}} ]$$

may be used to calculate the received radar signal for an object at a 50 m distance from the access point transmitting the radar signal in question and at 5 m distance from the receiving UE. Assuming a bistatic radar cross section of 0.01 meter squared,

$${P}_{r e c e ived} = 38 dBm + 0 dB + 23 dB + 10 log ( 0.00 {3}^{2} \cdot 0.01 / ( {( 4 \cdot 3.14 )}^{3} \cdot 62500 ) ) = - 90 dBm \text{=>} SNR = - 90 ( - 110 ) = 20 dB$$

It would thus be possible to detect an object with a bistatic radar cross section of 0.01 meter squared at 5 m distance from the UE with a correlation time of 10 us, at a distance of 50 m from a transmitting access point. The transmit (Tx) power is adequate in this case.

The beamwidth is inversely proportional to the number of antennas in the transmitting antenna array along the beam dimension, and it is also dependent on the beam angle. With an access point having 2000 antennas, there could be four panels with 500 antennas per panel. Such a panel could use a geometry with 50 times 10 antenna elements. Fifty elements in azimuth yields a 3 degrees half-power beamwidth in the worst case of 45 degree beam angle. At a distance of 50 m from the access point such a beam is 2.5 m wide, and at 20 m it is 1 m wide, corresponding to a similar precision in a system with narrow bandwidth relying completely on the ability to form narrow beams for radar resolution.

An example UE is assumed to have 100 antenna elements per panel. Assuming a 10×10 array, that element count corresponds to a 15 degree beamwidth. A 5 m distance from the UE thus corresponds to a receive beam width of 1.3 m, so an object 5 m from the device and 20 m from the access point could be resolved from other targets about 1 m apart. This resolution should be sufficient in many cases, and if more is needed there are also techniques for forming nulls that are sharper than beams that can be used for further resolution improvements.

It should be noted that in case of objects being further apart not causing problems with separating the targets, each target position could be estimated with about half the beamwidth precision, and same goes for positioning of the device itself using line-of-sight signals, where the accuracy will be of the order of half the access-point beamwidth (assuming the access point to have a narrower beam than the UE).

For a 30 GHz example, assume the UE has 16 antenna elements per panel, and the access points have 256 antenna elements spread over their respective panels, with the radar signals transmitted by the access points having a 30 GHz center frequency. Further, assume a 7 dB total noise figure for the receiver of the UE, and assume a 14 dBm output power of each access point antenna, i.e., 38 dBm total radiated power and assuming omni-directionality for simplicity, the EIRP is 38 dBm.

With an assumed radar pulse length of 10 us, and an integration time of the same length, the received radar signal noise becomes

$$- 174 dBm + NF - 10 log ( integration time ) = - 174 + 14 + 50 = - 117 dBm .$$

Using the equation

$${P}_{r e c e ived} = {P}_{T X} + {G}_{T Xant} + {G}_{R Xant} + 10 log [ \frac{{λ}^{2} \cdot σ}{{( 4 π )}^{3} \cdot {R}_{Rx}^{2} {R}_{Tx}^{2}} ]$$

to calculate the received radar signal for an object at 50 m distance from a participating one of the access points and 5 m distance from the UE, and with a bistatic radar cross section of 0.01 meters squared,

$${P}_{r e c e ived} = 38 dBm + 0 dB + 15 dB + 10 log ( {0.01}^{2} \cdot 0.01 / ( {( 4 \cdot 3.14 )}^{3} \cdot 62500 ) ) = - 88 dBm \text{=>} SNR = - 88 ( - 117 ) = 29 dB .$$

Again, it would be possible to detect an object with a bistatic radar cross section of 0.01 meters squared at 5 m distance with a correlation time of 10 us, at a distance of 50 m from an access point, so the power is adequate.

The worst case beamwidth from an access point, assuming a 16×4 panel size, becomes 9 degrees. At 50 m that corresponds to almost 8 m, and at 20 m distance it corresponds to 3 m. To achieve about 1 m precision, the access point needs to be no more than about 7 m away from the object to be detected. If the device has 4×4 panels, the beamwidth becomes 35 degrees, so the UE must be no more than 1.5 m from the object to get 1 m precision. From this example, it is clear that the technique with narrow beams to achieve high radar precision is generally more suitable at high frequencies. While the radar precision at 100 GHz becomes adequate thanks to the antenna arrays with large size in number of wavelengths used in both access points and UEs, this is not the case at 30 GHz. For systems at or around that frequency, multi-static radar operation achieves high radar resolution based on using wide bandwidth radar signals and tight time synchronization. A UE supporting different frequency bands could, for example, use multi-static radar based on spatial domain information for one band, both spatial and time domain for a second band, and time domain only in a third band together with radar correlation or other information combining between the bands.

As for codes and modulation, in the wideband case, with a bandwidth of up to a few GHz and a signal length of 10 us, the total length of the transmitted sequence is tens of thousands of samples. It is, however, not necessary to have such a long sequence stored in memory at a receiving UE for use in decorrelation. The sequence that is unique to each access point, and possibly to some associated beam directions, could be shorter and repeated several times in one transmission to save memory. Repeating a shorter sequence provides performance equivalent to full-length sequences if the number of different sequences does not approach the short sequence length. Alternatively, to correlate with a longer sequence, the sequence may also be generated on the fly or a specific sequence hypothesis, including the current T and F error hypothesis.

The correlation should be performed coherently across the full duration, to achieve the full decorrelation processing gain. If that is not feasible, e.g., due to frequency error that leads to phase drift over time, correlation could be performed over parts of the full duration and non-coherently combined.

When it comes to modulation, in some embodiments, a low peak to average power ratio is preferred to maximize the output power of the radar signal. Low order modulation is thus preferred, with constant envelope property, e.g., the symbols are located on a circle in the QAM constellation, like Binary Phase Shift Keying (BPSK) or Quadrature PSK (QPSK). Other PSK options (e.g., 8-PSK) or other constant-envelope signal designs (e.g., Frequency Shift Keying (FSK)) may be used. Alternatively, if the radar illumination signals are generated using the same framework as communications signals, e.g., using OFDM modulation, the frequency domain signal choice may not be able to fully control the time domain signal Peak-to-Average-Ratio (PAR) and the resulting power amplifier (PA) efficiency, especially if the radar signals are only transmitted in a sub-band of the carrier. In that case, a lower-PAR signaling scheme, e.g., Discrete Fourier Transform Spread (DFTS) OFDM may be used.

For the lower bandwidth signal for instance a 100 MHz bandwidth could be used, corresponding to 1000 samples in 10 us. That arrangement should be sufficient to provide codes for the different base stations and beams, using the modulations above with low PAR. The 10 us pulse length is short enough to avoid problems with object speeds also in road traffic. For instance, a change in bistatic radar path of 75 m/s results in 0.75 mm movement in 10 us, which is equal to one quarter of a wavelength at 100 GHz. If there should be no high speed objects in an area, a longer pulse length could be chosen, with a corresponding lower output power and bandwidth. A 100 MHz bandwidth provides an ability to separate radar echoes with about 3 m difference in bi-static radar path length. While not sufficient for high resolution path distance measurements, it provides an important possibility to distinguish echoes that could come from sidelobes.

Regarding the use of transmit beam sweeps for radar-signal transmission at the access points participating in a multi-static radar event, one possibility is to assign each beam direction from each access point a separate code, although it may be beneficial to reduce the number of codes. In the case of beam sweeps, where each access point transmits a single beam at a time—i.e., transmits in different beam directions at successive times during a sweep interval—it is sufficient to use a single code per access point. Information about the sweep pattern, e.g., a simple beam rotation, can be transmitted to UEs as part of multi-static radar configuration information transmitted by the network. A rotation means that beam direction is shifted step by step in a clock-wise or counterclockwise pattern. In the simplest case, all access points use the same rotation speed, and rotate in phase, i.e., all transmit beams in the same direction, either simultaneously or sequentially. Then a minimum of information is needed by the UEs to receive the beam-swept radar signals. More advanced patterns may be used, such as where the rotation speed could be different for different access points, or if the rotation speed is the same, different access points can be at different phases of the rotation cycle.

More than one beam could be transmitted by each access point simultaneously, in the beam sweeping context. For instance, three beams could be used in a rotating pattern, where one beam is leading, the second is the center beam, and the third is lagging, i.e., comes after the other two in the rotation. The beams could be close together in directions to resolve objects around the center direction, and then a larger step is taken to a new center direction. Another case is that the three beams are spread out 120 degrees apart. Either way, when multiple beams are transmitted from an access point participating in a multi-static radar transmission, each should have a separate code or radar signal sequences, so in the case of three beams, there will be 3×N codes needed, where N is the number of participating access nodes.

Regarding radio protocol aspects, implementation of multi-static radar operation in a wireless communication network, the protocol should support initiation of multi-static radar operation, e.g., on a dynamic basis, such as triggered by the network in response to an incoming request from a UE. That is, multi-static radar operation is provided by the network on a demand basis, in one or more embodiments. Further, in one or more embodiments radar configuration information may be provided to the UE by means of control signaling from an access node. An advantageous feature is that an access node acting in a serving role towards a UE in the communications sense may be used to transmit multi-static radar configuration information to a UE, for use by the UE in determining the transmission times, codes, frequencies, locations of one or more of the transmitting access nodes or any other transmission parameters needed for successful reception of the radar signals by the UE.

In one or more embodiments, the multi-static radar configuration information provided to the UE by the serving access node includes information for all the participating access nodes. Additionally, the UE may use the serving access node to send requests for multi-static radar operation, and to provide the network with information indicating its multi-static radar capabilities, e.g., in terms of signal bandwidths, number of simultaneous beams that can be received, etc., or indicating its radar performance requirements, which can be used by the network to tailor the multi-static radar configuration. The UE may also use the serving access node to feed back results of multi-static radar signal measurements, or to indicate whether an ongoing multi-static radar operation needs to be modified, e.g., in terms of modifying which access nodes are participating, or modifying the radar signals themselves.

With respect to the technical specifications promulgated by the Third Generation Partnership Project (3GPP) for wireless communication networks, the main functionality of controlling multi-static radar operation by the network may be implemented within a Radio Resource Control (RRC) protocol, such as the 3GPP RRC functionality (TS38.331 for NR specifications). Further, UE capability signaling providing information to the wireless network indicative of functions and combinations of them supported by the UE could be extended with information elements on aspects related to the UE capability to receive radar signals, such as time and frequency constraints, concurrent functionality of joint communication and sensing etc. Further, a UE could use such control signaling layer as e.g., enabled via the RRC protocol to transmit a request of activation of the radar functionality as well as to receive a radar function activation indication from the network. The UE request could include parameters to determine suitable radar transmission characteristics, such as beam sweeping parameters (beam widths, beam sweep pattern etc.), transmission frequency, time information, number of transmitting nodes, an area to be illuminated (e.g., based on UE position, detected cells, or geo-positions from a map), etc. It can be noted that other signaling protocol layers and functionalities may be utilized, either in combination or instead of the example of using RRC protocol. Examples include but are not limited to signaling such as physical layer or MAC protocols and methods, e.g., downlink and uplink control signaling on these layers, or higher protocol layers such as non-access stratum (NAS) signaling protocols.

In order to utilize the multi-static radar operation of the network, a UE needs to receive detailed information about how to detect the radar transmissions, meaning time, frequency and space of the transmissions, as well as information about any coding applied to the individual radar signals and the location of the transmitting access nodes. As one example of implementation into 3GPP protocols, the existing neighbor cell information concept within RRC could be extended to provide the required information to a UE as configuration information indicating the multi-static radio configuration used for transmitting radar signals for the UE. In existing legacy networks, the neighbor cell information is broadcasted in system information (e.g., SIB3, SIB4, SIB5) and includes information useful for the UE to identify neighbor cells via the physical cell identities. In one or more embodiments, new SIBs are used to transmit multi-static radar configuration information, e.g., an access node transmits a SIB that contains transmission parameters for radar signal transmissions by it and neighbor cells. Such a SIB could include but not be limited to resource indication (time, frequency, space), location information, signal structure (what type of signal is used) and how to identify individual beams. Other implementation possibilities include using dedicated signaling for informing of all or parts of the radar transmission information. For example, the beam-specific information may be dynamic, which could make such information more suitable to be transmitted to respective UEs via UE-specific signaling. Such UE specific signaling could be implemented via a downlink control information (DCI) signaling, which may be transmitted on lower layers, such as Layer 1 protocol.

The radar signal transmissions from the access points could utilize existing transmission types suitable for radar usage. Such signaling examples may include sync signal block (SSB) transmissions, reference signals such as the channel state information reference signals (CSI-RS) or positioning reference signals (PRS). Alternatively, or in addition, dedicated radar signals could be added as new transmission signals, not available in current 3GPP specifications. In one or more examples, such new radar transmission signals can be adjusted in power, beams, resources etc., to better match the dynamic needs of radar functionality within the system, while the drawback would be the need to use additional resources in the network.

During a multi-static radar transmission, the UE may be requested to perform measurements and provide feedback on the radar reception, in order for the network to tailor and adjust the transmitting to fit the UE needs. Such feedback could include indications on the detection quality of radar signals, and it may include UE requests on adjustments of the radar transmissions characteristics, similar to the UE initiation request parameters. Such UE signaling could be conducted by adding new signaling functions into the protocols, such as new uplink control information (UCI) formats for lower layer signaling, or as new RRC signaling or Non-Access Stratum (NAS) signaling formats.

Generally, the radar functionality and the described signaling above indicates that the radar functionality would work most efficiently when a UE is in an active/connected mode with respect to the access node providing it with multi-static radar configuration information. However, sufficient information at least for basic radar sensing by a UE may be transmitted using broadcasted information, with more specific or more detailed information provided to the UE upon connection to the network, in instances where the UE needs to perform more than basic radar sensing. Other examples of a UE using the radar functionality while in an idle/inactive mode includes the possibility for a UE to store configuration information received from the network while the UE is in an active mode and then later using such information for radar sensing during idle mode. In such case, there may be a validity timer indicated in the radar configuration, wherein the UE may assume that the received information would be valid until timer expiry. A UE may also explicitly request radar transmissions, and those transmissions may have some validity period defined for them, or they may be terminated responsive to a termination request.

As for beamforming at a UE for receiving radar signals, the example UE uses analog beamforming or digital beamforming, or a hybrid of analog and digital beamforming. With analog beamforming, the UE may have multiple antenna panels facing different directions and may form an analog beam in each antenna panel, to receive radar signals. The UE can simultaneously sample the signals received by all the panels and then apply the corresponding code of each access-point beam on the sampled signals to extract the radar signals from each access point and any corresponding echoes. In addition, different types of on-demand sweeping analog beams can be used on each panel to cover the required space.

With digital beamforming, a UE can simultaneously sample the signals transmitted by multiple access nodes, from multiple directions, and post-process the signal samples to extract the desired information. With digital beamforming, it is feasible for the UE to synthesize multiple receive beams simultaneously from each of its antenna panels, which reduces the time needed to scan the directions of interest and enables radar tracking of faster moving objects or faster self-movements.

With the above in mind, the techniques disclosed herein in the context of one or more embodiments include, from the network perspective, a method for transmitting signals for multi-static radar operation, with the method comprising transmitting radar-friendly signals from a set of at least two NW nodes, transmitting configuration information to a UE in a “collected” sense, e.g., where a serving access node transmits multi-static configuration information containing details for the radar transmissions of all access nodes participating in a given multi-static radar event. The network may indicate to UEs whether they can transmit requests for multi-static radar support, or whether they can request details regarding multi-static radar operation by the network. The method may further include the network initiating multi-static radar operation or modifying ongoing multi-static radar operation within one or more network areas, in response to signaling from one or more UEs, with such signaling comprising any one or more of requests for multi-static radar support, information indicating radar-sensing capabilities of one or more UEs, or information indicating radar-sensing requirements of one or more UEs. Adapting multi-static operation comprises adapting transmission times, radar signal bandwidth, radar signal frequency, radar signal modulation scheme, radar signal beamforming regarding beam shape or beam direction, etc.

UEs may communicate such information via RRC signaling. Idle/inactive UEs may transmit at least some of such information during Random Access (RA) procedures, e.g., using small/early data transmission techniques.

A centralized network node of the network or distributed logic in respective access nodes provides for coordination of multi-static radar operation across multiple access nodes, including the exchange of coordinating configuration information between or among the participating access nodes. Determining the multi-static radar configuration for a set of access nodes participating in multi-static radar operations may include information about transmission times, frequencies, bandwidths, etc., and UEs are provided with information indicating such resources or other relevant transmission parameters for “tuning” or otherwise configuring their receiver operations, for reception of the radar signals.

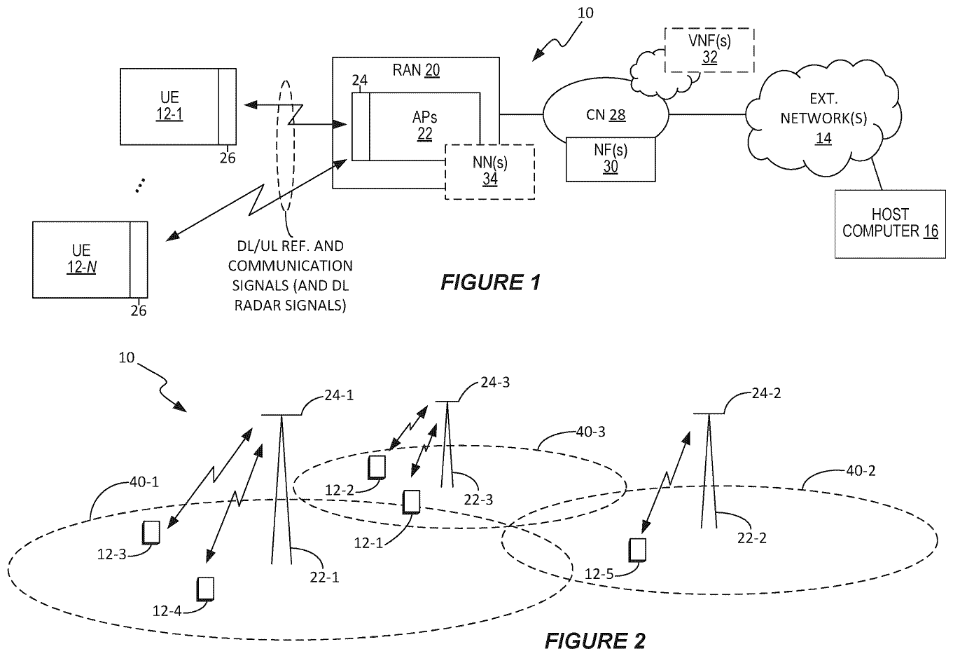

Turning to example illustrations, FIG. 1 is a block diagram of a wireless communication network 10 according to an example embodiment. The network 10 provides one or more types of communication services to UEs 12, such as by acting as an access network that communicatively couples respective ones of the UEs 12 to other devices or systems. For example, the communication network 10 communicatively couples to one or more external networks 14, such as the Internet or other Packet Data Network (PDN) that provides access to other devices or systems, such as the host computer 16 shown in the depicted example. The host computer 16 comprises, for example, a computer server that provides one or more types of data or communication services.

The communication network 10 comprises, for example, a wireless communication network, such as a cellular network operating according to 3GPP specifications. In the depicted example, the wireless communication network 10—network 10, hereafter—includes a Radio Access Network (RAN) 20. The RAN 20 includes radio network nodes that may be referred to as access points 22. Each access point 22 operates as a radio access point for communicatively coupling UEs 12 to the network 10. Each access point 22 includes an antenna system 24, which is a beamforming antenna assembly in one or more embodiments, e.g., to provide transmit beamforming or receive beamforming, for communication signals or radar signals. Here and elsewhere, the word “or” means one or the other or both, unless otherwise specified or clear from the context.

The UEs 12 each include an antenna system or subassembly 26, such as one or more antenna panels, with each panel comprising an array of antenna elements and associated radio signal circuitry paths. In at least one embodiment, one or more of the UEs 12 is configured for receive beamforming, e.g., digital, analog, or hybrid beamforming. In particular, one or more such UEs 12 use radar services provided by the network 10—i.e., they act as radar receivers and perform radar processing with respect to the transmission by the network 10 of radar signals transmitted by two or more APs 22 participating in multi-static radar operations.

Further included in the network 10 is a core network (CN) 28, which controls communication services provided by or through the network 10, controls access and authorization of respective UEs 12, manages mobility of UEs 12 within the network 10, and provides routing and address handling for data flowing between respective ones of the UEs 12 and the external network(s) 14. Various network functions (NFs) 30 combine or cooperate to provide overall control of communication data flows through the network 10 and to provide overall management of the UEs 12. At least some such functions may be implemented as virtualized network functions (VNFs) 32, in which the logical functionality of the respective functions is instantiated in a virtual machine running on a host computer system.

One or more of the UEs 12 are “radar UEs” that perform one or more types of radar-sensing operations that rely on multi-static radar support by the network 10. That is, one or more of the UEs 12 are configured to receive radar signals from multiple access points 22 of the network 10 and process the received radar signals for determination of the location of the UE 12 or for detecting one or more objects proximate to the UE 12. To that end, the network 10 includes logical functionality by which it configurates sets of access points 22 for coordinated multi-static radar operation and by which it provides UEs 12 with corresponding configuration information, enabling such UEs 12 to detect and process the transmitted radar signals. FIG. 1 depicts such logical functionality as one or more network nodes (NNs) 34.

The network 10 may include multiple network nodes 34, e.g., where each one is centrally responsible for coordinating multi-static radar operations within respective network areas, where “network area” refers to a defined sub-grouping of network coverage areas or network equipment providing such coverage. For example, the network 10 may be subdivided into multiple network areas with each such area containing some number of access points 22. Alternatively, the network node(s) 34 may be implemented on a distributed basis, e.g., by implementation in a number of access points 22. As such, any reference herein to a “network node” performing multi-static radar operations or being configured to carry out such operations may be understood as a reference to one or more physical entities that include processing circuitry configured to implement the involved processing logic.

FIG. 2 provides additional example details for the network 10, showing three access points 22-1, 22-2, and 22-3, having respective antenna systems 24-1, 24-2, and 24-3, configured for transmit beamforming or receive beamforming or both. Each access point 22 provides network coverage over one or more respective network coverage areas 40, e.g., access point 22-1 provides network coverage area 40-1, access point 22-2 provides network coverage area 40-2, and access point 22-3 provides network coverage area 40-3. Note that the use of reference number suffixes herein is limited to instances where suffixes aid clarity and un-suffixed reference numbers are used otherwise.

“Network coverage area” refers to a geographic region in or over which the network 10 provides communication-signal strengths meeting some minimum threshold, and the illustrated network coverage areas 40 correspond with “cells” or “sectors” or “beams” of the network 10, in that they may be differentiated in terms of specific communication resources, such as carrier frequencies, scrambling codes, identifiers, etc. In one or more embodiments, the access points 22 use directional beams to provide the network coverage areas 40, e.g., with individual beams covering sub-areas within the network coverage areas 40. For multi-static radar operation, the participating access points 22 in one or more embodiments transmit radar signals, also referred to as illumination signals, in their respective network coverage areas 40, or within sub-areas thereof, e.g., using transmit beamforming.

As an example, in the context of FIG. 2, assume that the UE 12-1 is a radar UE and transmits a request for multi-static radar support, e.g., for object detection or self-positioning of the UE 12-1. The network node(s) 34 of the network 10 respond to the request by determining a multi-static radar configuration that defines, for example, which access points 22 are included in the set of access points 22 that will transmit radar signals for the UE 12. For example, the set includes the access points 22-1, 22-2, and 22-3 given their locations relative to the UE 12-1, with each one of them transmitting one or more radar signals for reception by the UE 12-1. For example, each access point 22-1, 22-2, and 22-3 transmits one or more radar signals as directional beams that are oriented for illumination of a target region, which may be a region in which the UE 12-1 is located or a region proximate to the UE 12-1. The target region may be identified in terms of the involved network coverage area(s) 40, e.g., the target region may be identified in terms of beam coverage areas.

In another example of target-region determination or otherwise determining the set of access points 22 that will transmit radar signals for a UE 12, consider that the network 10 may consist of multiple cells, and each cell may consist of multiple transmit beams. The UE 12 may be connected to the network 10 via at least one active beam within one cell. As part of mobility management of the UE 12 by the network 10, the network 10 may receive information from UEs about detected neighbor cells. In other words, the network 10 may have a neighbor cell list of candidate neighbor cells that UEs typically report as detected and it may also have an up to date list of cells any particular UE 12 has reported detected recently. Once a UE 12 is to be configured to receive radar signals, the network 10 may, for example, select one of more of the beams of the active cell to be part of the radar transmission. As another example, selection includes the current cell and one or more of the neighboring cells, as known from neighbor-cell lists or other information.

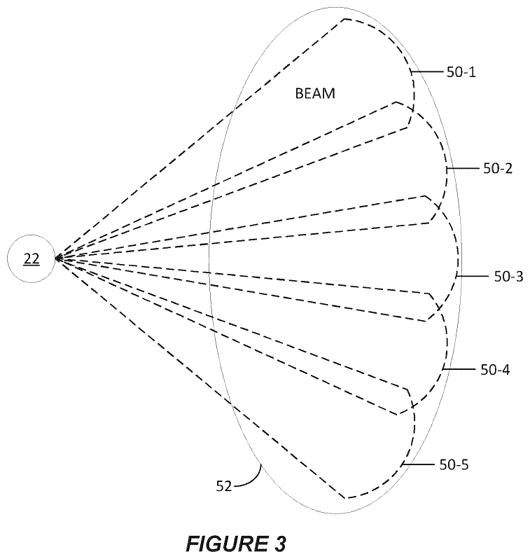

FIG. 3 illustrates a beamforming example, where a given access point 22 participating in a multi-static radar operation transmits a radar signal in each of one or more beams 50, e.g., 50-1, 50-2, 50-3, 50-4, and 50-5, with each beam having a beam shape and angle resulting in the illumination of a corresponding portion or sub-region of a target region 52. Here, the target region 52 is simply the region targeted for illumination by the multi-static radar operation and as noted, it may be coextensive with one of the defined network coverage areas 40, or otherwise may be specified in terms of the network coverage areas 40 that are involved. The target region 52 may be covered or swept by multiple beams.

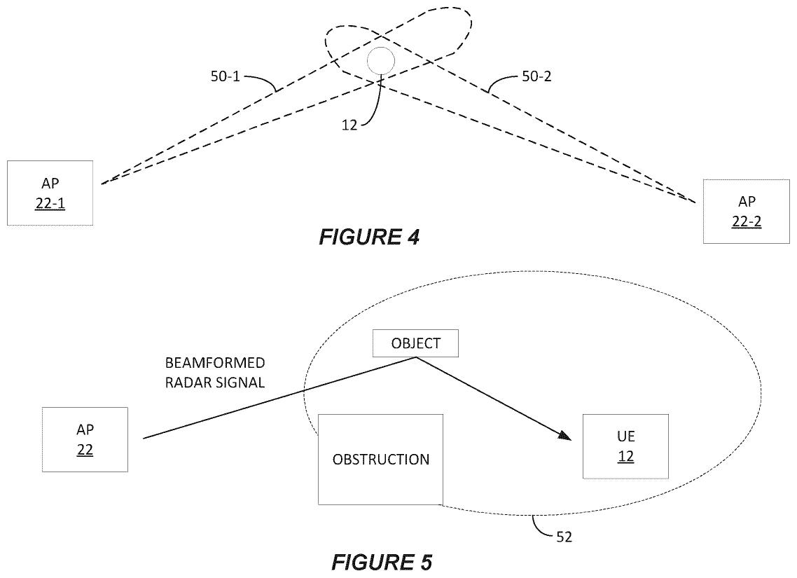

FIG. 4 illustrates an example of self-positioning by a UE 12, based on the UE 12 receiving a radar signal on a LOS path, from each of at least two access points 22, where the radar signals are transmitted via beams 50 that are comparatively narrow. Processing circuitry in the UE 12 according to one or more embodiments is configured to compute the location of the UE 12 based on receiving radar signals transmitted from at least two geographically-separate access points 22, on respective LoS paths. To the extent that the UE 12 receives a given radar signal via multi-path and the multi-path includes a LoS path, the UE 12 may select the strongest one among the multi-path signals as being the LoS path and use that strongest signal for radar processing. The same logic or processing may be used to filter or ignore sidelobes of the beams conveying the radar signals.

FIG. 5 is a block diagram illustrating the fact that radar sensing by a UE 12 according to the multi-static radar operation described herein does not require the access points 22 participating in multi-static radar transmissions for a given UE 12 to have LoS paths to the UE 12, at least not in the context of object detection rather than self-positioning of the UE 12. Instead, it is sufficient for the participating access points 22 to have LoS paths to the target region 52 being illuminated. Particularly, for the UE 12 to accurately detect the position of an object proximate to the UE 12, the participating access points 22 should have LoS paths to the object, and the UE 12 should have an LoS path to the object. Under those circumstances, the object is illuminated by at least one radar signal from each access point 22 via a corresponding LoS path, and the UE 12 receives the reflection of that at least one radar signal from each access point via its LoS path with the object.

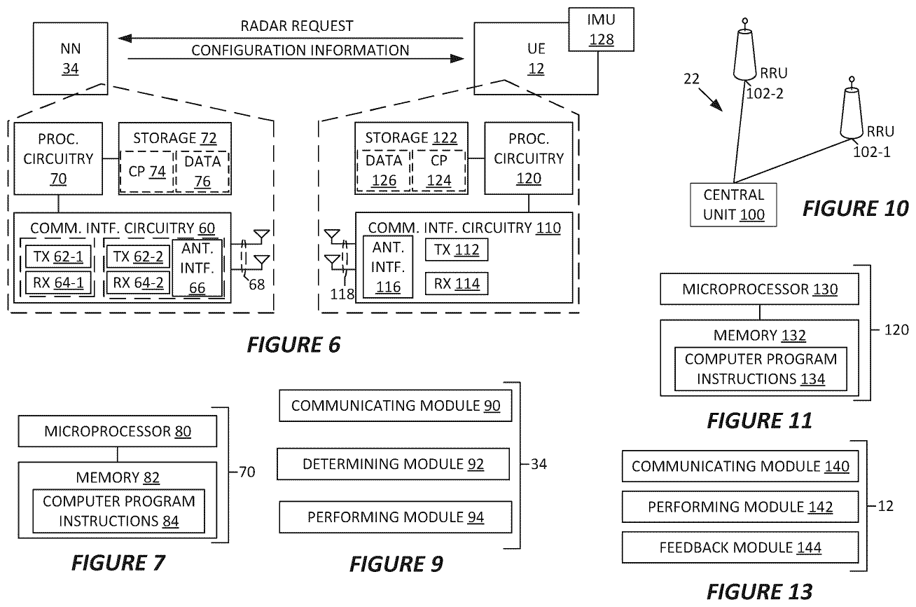

FIG. 6 illustrates an example network node 34 that is configured to perform at least some of the network-side operations described herein for multi-static radar operation. The diagram also illustrates an example UE 12 that is configured to perform the UE-side operations described herein for multi-static radar operation.

The network node 34 includes communication interface circuitry 60, which includes first transceiver circuitry comprising transmitter circuitry 62-1 and receiver circuitry 64-1, where such circuitry provides physical-layer circuitry for transmitting and receiving signals via a corresponding physical medium, either wired or wireless. The first transceiver circuitry is configured for transmitting and receiving signaling, e.g., messages, to/from one or more other nodes in the network 10. As an example, the first transceiver circuitry comprises an Ethernet or other data-networking interface. In embodiments where the network node 34 is a centralized node that coordinates or manages multiple access points 22 with respect to multi-static radar operations, the first transceiver circuitry communicatively couples the network node 34 to one or more of those access points 22, or to another node in the network 10 that is communicatively coupled to one or more of those access points 22.

In other embodiments, each access point 22 includes all or part of the network node 34. For example, among the overall population of access points 22 in the network 10, or among some sub-set of them, each access point 22 is configured to act as a respective network node 34 that is operative to determine multi-static radar configurations for any given multi-static radar event involving the access point 22 or any of its neighboring access points 22. Thus, as suggested in the diagram, the network node 34 in one or more embodiments includes at least second transceiver circuitry comprising transmitter circuitry 62-2 and receiver circuitry 64-2 that is configured for the transmission and reception of signaling via a radio air interface. Such circuitry is coupled to one or more antennas 68 via antenna interface circuitry 66, which together correspond to the antenna systems 24 shown in association with access points 22 in FIG. 1. In other words, in one or more embodiments, the network node 34 may be understood as being integrated in or otherwise implemented within each of one or more access points 22 within the network 10, with each such access point 22 being operative to coordinate the multi-static radar operations of itself and one or more neighboring access points 22, and to be coordinated by any one or more of its neighboring access points 22.

Regardless of whether implemented in standalone or integrated fashion, the network node 34 comprises processing circuitry 70, which in one or more embodiments includes or is associated with storage 72 that stores, for example, one or more computer programs (CPs) 74 and data 76. The data 76 comprises, for example, information useful in determining multi-static radar configurations, such as information defining neighbor relations among access points 22, information indicating network coverage areas 40, access point locations, radar signal transmission parameters, e.g., selectable options and default choices for timing, coding, beam configuration(s), etc.

Broadly, the processing circuitry 70 comprises fixed circuitry or programmatically configured circuitry or a mix of both. In one or more embodiments, such as shown in FIG. 7, the processing circuitry 70 comprises one or more microprocessors 80 or other digital processors that is/are specially adapted to carry out at least some of the network-side operations described herein for multi-static radar operation, based on the execution of computer program instructions stored in a memory 82. The computer program instructions 84 are contained in the one or more computer programs 74 shown in FIG. 6, for example, and the memory 82 comprises all or part of the storage 72 shown in FIG. 6. In general, the storage 72 comprises one or more types of computer-readable media providing persistent storage of program instructions and data, and may include various types of memory or storage devices, such as SRAM, DRAM, NVRAM, EEPROM, FLASH, etc.

With the example details of FIGS. 6 and 7 in mind, a network node 34 according to one or more embodiments comprises communication interface circuitry 60 and processing circuitry 70 that is operatively associated with the communication interface circuitry 60. “Operatively associated” means that the processing circuitry 70 is configured to use the communication interface circuitry 60 to transmit or receive signaling conveying messages or other information. The processing circuitry 70 is configured to determine a multi-static radar configuration for illumination of a target region 52 of the network 10 via the transmission of illumination signals by set of access points 22 of the network 10. Each access point 22 in the set acts as a respective radar transmitter in the multi-static radar configuration and a UE 12 acts as a radar receiver in the multi-static radar configuration. Further, the processing circuitry 70 is configured to transmit configuration information for the UE 12, indicating the multi-static radar configuration. For example, if the network node 34 is an access point 22 serving the UE 12, the network node 34 may transmit radio signaling indicating the multi-static radar configuration, for reception by the UE 12 according to the particulars of the air interface that links the access point 22 to the UE 12.

If the network node 34 is not an access point 22 or otherwise does not have radio connectivity with the UE 12, the network node 34 transmits the multi-static radar configuration by sending signaling to another node in the network 10 that has direct or indirect connectivity with the UE 12. For example, the processing circuitry 10 is configured to transmit the configuration information to the UE 12 by transmitting the configuration information from a serving access point 22, e.g., by causing the configuration information to be transferred to the serving access point 22, for transmission to the UE 12.

The configuration information comprises, for example, assistance information for receiving the illumination signals at the UE 12. The assistance information at least indicates positions of respective access points 22 in the set of access points 22. Unless otherwise noted, references to the configuration information as indicating the “positions” of the respective access points 22 in the set of access points 22 shall be understood as referring to the locations of the involved transmit antennas. For example, if an access point 22 uses a distributed architecture in which higher-level communications processing is implemented in a node physical separate from the antenna(s) and physical-layer radio equipment, the “position” of the access point 22 for purposes of the configuration information is the position (location) of the antenna(s).

In at least one embodiment, the configuration information comprises assistance information indicative of the locations of respective access points in the set of access points, and wherein the assistance information further indicates one or more transmission parameters of the illumination signals, including any one or more of signal identifiers, signal codes, signal frequencies, signal timing, or beamforming configuration information associated with beamformed transmission of the illumination signals. As noted, the illumination signals may be dedicated for radar sensing or may be communication signals; in an example embodiment, the illumination signals are communication reference signals used by the network 10.

To determine the multi-static radar configuration to be used, the processing circuitry 70 in one or more embodiments includes in the set of access points 22 only access points 22 that have LoS illumination towards at least a portion of the target region. As such, in at least one embodiment, the processing circuitry 70 is configured to consider the target region 52 to be illuminated, which may be a particular network coverage area 40 associated with serving the UE 12 in a communications sense and select as participating access points 22 two or more access points 22 that include the serving access point 22 or having neighbor relations therewith and have LoS paths to the target region 52.

Determining the multi-static radar operation further comprises, in one or more embodiments, the processing circuitry 70 being configured to determine whether to use narrowband illumination signals or wideband illumination signals or both narrowband and wideband illumination signals. Such operations may be based on considering at least one of: multi-static radar capabilities indicated by the UE 12 or multi-static radar requirements indicated by the UE 12.

In an example embodiment or scenario, the UE 12 is one among two or more UEs 12 in the target regions or in one or more neighboring regions that request multi-static radar operation. In at least one embodiment, the processing circuitry 70 is configured to determine the multi-static radar configuration in joint consideration of multi-static radar needs or capabilities respectively indicated by the two or more UEs 12.

Transmitting the configuration information to the UE 12 comprises, for example, broadcasting all or parts of the configuration information for reception by the UE 12. As such, in one or more embodiments, the processing circuitry 70 is configured to transmit the configuration information to the UE 12 based on broadcasting at least some of the configuration information from a serving access point 22 of the UE 12, or otherwise causing it to be broadcasted. “Broadcasting” refers to transmission of information on signaling channels common to multiple UEs, such as may be used for the transmission of synchronization and access information needed by UEs 12 to connect to the network 10 via a particular access point 22.

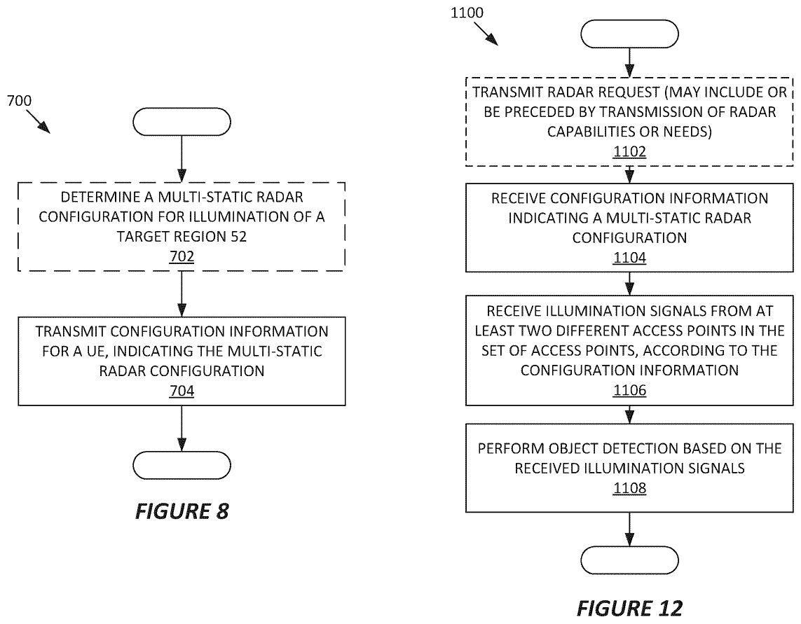

FIG. 8 illustrates a method 700 implemented by a network node 34 in a wireless communication network 10. The method 700 comprises the network node 34 transmitting (Block 704) configuration information for a UE 12. The configuration information indicates a multi-static radar configuration in which the UE 12 acts a radar receiver and a set of access points 22 in the network 10 act as radar transmitters, transmitting respective illumination signals for illumination of a target region 52.

In one embodiment, the network node 34 is a serving access point 22 of the UE 12 and transmitting the configuration information comprises performing a radio transmission. In another embodiment, the network node 34 is not the serving access point 22 and transmitting the configuration information comprises sending the configuration information to the serving access point 22, for radio transmission by the serving access point 22.

In at least one embodiment, the method 700 includes the step or operation of determining (Block 702) the multi-static radar configuration for illumination of the target region 52. In one example embodiment, a network node 34 that is remote from the serving access point 22 of the UE 12 is the entity that performs the determining operations of Block 702, and it provides the serving access point 22 with the configuration information, for over-the-air transmission to the UE 12. However, the serving access point 22 in one or more embodiments operates as the “network node 34” that determines the multi-static radar configuration, meaning that the transmitting step (Block 704) comprises one or more radio transmissions by the serving access point 22.

Transmitting the configuration information to the UE 12 comprises, for example, transmitting the configuration information from a serving access point 22. In at least one embodiment, the method 700 includes, at the serving access point 22, receiving a request from the UE 12 for activation of multi-static radar operation. The request indicates the target region 52 to be illuminated. Correspondingly, the method 700 further includes, responsive to the request, determining the multi-static radar configuration and transmitting the configuration information to the UE 12.

One or more embodiments of the method 700 further comprise, at the serving access point 22, exchanging signaling with at least one additional access point 22, to establish the multi-static radar configuration. That is, the serving access point 22 may coordinate with access points 22 included in the set of (participating) access points 22, to configure radar-signal transmission parameters at each one, or otherwise agree on radar-signal transmission parameters, for coordinated transmission of the radar signals to be transmitted as part of the multi-static radar operation.

The configuration information comprises, for example, assistance information indicative of the locations of respective access points in the set of access points, and wherein the assistance information further indicates one or more transmission parameters of the illumination signals, including any one or more of signal identifiers, signal codes, signal modulation scheme, signal frequencies, signal timing, or beamforming configuration information associated with beamformed transmission of the illumination signals.

The method 700 in one or more embodiments further includes transmitting the illumination signals from the set of access points 22, according to the multi-static radar configuration. Transmitting the illumination signals comprises, for any one of the access points 22 in the set of access points 22, transmitting one or more respective ones of the illumination signals, according to the multi-static radar configuration. Transmission of the illumination signals comprises, for example, performing non-concurrent transmissions among the access points 22 included in the set of access points 22. Alternatively, transmitting the illumination signals from the set of access points 22 comprises performing concurrent transmissions among the access points 22 included in the set of access points 22. Such variations may be considered as part of determining the multi-static radar configuration and may be decided dynamically in dependence on prevailing circumstances, UE needs, etc., as part of determining the multi-static radar configuration.

Transmitting the illumination signals comprises, for example, for each access point 22 included in the set of access points 22, performing one or more beamformed transmissions directed towards all or part of the target region 52. And, as noted, determining the multi-static radar configuration comprises, for example, including in the set of access points 22 only access points that have LoS illumination towards at least a portion of the target region 52. Also noted, determining the multi-static radar configuration may further comprise determining whether to use narrowband illumination signals or wideband illumination signals or both narrowband and wideband illumination signals based on at least one of: multi-static radar capabilities indicated by the UE 12 or multi-static radar requirements indicated by the UE 12.

The UE 12 may be one among two or more UEs 12 in the target region 52 or in one or more neighboring regions that request multi-static radar operation. Determining the multi-static radar configuration in such instances may comprise determining the multi-static radar configuration in joint consideration of multi-static radar needs or capabilities respectively indicated by the two or more UEs 12.

In at least one embodiment, determining the multi-static radar configuration comprises at least determining membership in the set of access points 22 that will participate in the multi-static radar transmission. For example, the serving access point 22 or another network node 34 identifies the access points 22 that are associated with the target region 52. Here, “associated with” means having positional relevance to the target region 52. An access point 22 that is not positioned in a way that allows it to transmit signals that illuminate the target region 52 is not associated with the target region 52. Conversely, an access point 22 that can illuminate all or a portion of the target region 52 is associated with the target region 52. Such illumination may depend on beamforming, where the access point 22 in question uses one or more directional transmission beams to illuminate the target region 52.

In at least one embodiment, only access points 22 that have LoS illumination of the target region 52 are considered to be associated with the target region 52—i.e., only LoS access points 22 are candidates for inclusion in the set of access points 22 that perform the multi-static radar transmission. The particular candidate access points 22 and the overall number of candidate access points 22 that are included in the set of access points 22 used to illuminate the target region 52 depends, for example, on any one or more of the following factors: how many candidate access points 22 there are, the particular radar-sensing needs of the involved UE(s) 12, the indicated radar capabilities of the involved UE(s) 12, the particular geometry relating the target region 52 to respective ones of the candidate access points 22, or the topology in or around the target region 52.

FIG. 9 illustrates an embodiment of a network node 34 comprising a plurality of processing units or modules that are configured to cause the network node 34 to carry out some or all of the processing operations or functions described for the method 700 or more generally attributed to network-side operations for support of multi-static radar transmissions. While the processing modules are comprised or otherwise implemented via physical processing circuitry, they may be realized in a virtualized computing environment executing on a host computer.

The depicted processing modules include a communicating module 90, e.g., for receiving requests originating from UEs 12 requesting multi-static radar operation by the network 10, or for transmitting the aforementioned configuration information for a UE 12, to indicate a determined multi-static radar configuration, or for exchanging coordination signaling by or between access nodes 22 when determining a multi-static radar configuration. Further included is a determining module 92 that is configured to determine multi-static radar configurations according to the technique(s) described herein. And, at least in embodiments where the network node 34 is implemented in one or more of the access points 22 participating in a given multi-static radar event, the modules include a performing module 94 that controls the transmission of radar signals according to the multi-static radar configuration, at least with respect to the illumination signals transmitted by that particular access point 22.

FIG. 10 illustrates another example configuration of an access point 22, wherein the access point 22 comprises a central unit 100 that comprises the processing and control circuitry and one or more remote radio units (RRUs) 102, with two shown for example as RRU 102-1 and 102-2. The RRUs 102 include the radio circuitry for air-interface communications and are operative to transmit illumination signals. As mentioned elsewhere herein, the “position” of access points 22 of the type illustrated in FIG. 10 shall be understood as being the position(s) of the RRU(s) 102 comprised in the access point 22, because it is the location of the radar-signal transmission source that is relevant to radar-processing operations at the UE 12.

Turning back to FIG. 6, the example UE 12 is operative to perform radar-signal reception and processing for self-positioning or object detection, in the context of multi-static radar operation by the network 10 where two or more access points 22 transmit radar signals for reception by the UE 12 directly or via reflection.

The UE 12 comprises communication interface circuitry 110 that includes transceiver circuitry comprising transmitter circuitry 112 and receiver circuitry 114. Such circuitry comprises a cellular radio modem, for example, that is configured to operate according to the applicable air interface specifications of the network 10 and it may support multiple Radio Access Technologies (RATs). The transmitter circuitry 112 and the receiver circuitry 114 interface to one or more antennas 118 via antenna interface circuitry 116, and such circuitry and antennas may be configured for transmit beamforming or receive beamforming or both. In at least one embodiment, the UE 12 is configured to perform receive beamforming for reception of illumination signals.

The example UE 12 further comprises processing circuitry 120, which may include or be associated with storage 122, e.g., for storing one or more computer programs 124 or data 126. As an example, the data 126 includes data received from the network 10, e.g., configuration information received from the network 10 that indicates a multi-static radar configuration. The data also may include provisioned or other more persistent information, such as radar capability information for the UE 12.

Broadly, the processing circuitry 120 comprises fixed circuitry or programmatically configured circuitry or a mix of both. In one or more embodiments, such as shown in FIG. 11, the processing circuitry 120 comprises one or more microprocessors 130 or other digital processors that is/are specially adapted to carry out at least some of the UE-side operations described herein for multi-static radar operation, based on the execution of computer program instructions stored in a memory 132. The computer program instructions 134 are contained in the one or more computer programs 124 shown in FIG. 6, for example, and the memory 132 comprises all or part of the storage 122 shown in FIG. 6. In general, the storage 122 comprises one or more types of computer-readable media providing persistent storage of program instructions and data, and may include various types of memory or storage devices, such as SRAM, DRAM, NVRAM, EEPROM, FLASH, etc.

FIG. 12 illustrates a method 1100 of operation by a UE 12 configured for operation with a wireless communication network 10. The method 1100 comprises the UE 12 receiving (Block 1104) configuration information indicating a multi-static radar configuration for illumination of a target region 52 of the network 10 via the transmission of illumination signals by a set of access points 22 of the network 10. In this context, each access point 22 acts as a respective radar transmitter in the multi-static radar configuration and the UE 12 acts as a radar receiver in the multi-static radar configuration. The method 1100 further includes the UE 12 receiving (Block 1106) the illumination signals from at least two different access points 22 in the set of access points 22, according to the configuration information, and performing (Block 1108) at least one of object detection or self-positioning, based on the received illumination signals.

Receiving the illumination signals “according” to the configuration information means that the signals are received and detected or processed at the UE 12, based on the UE 12 configuring its receiver circuitry or reception processing according to the times, frequencies, bandwidths, codes, identifiers, or other transmission parameters indicated for the illumination signals, such that it uses search spaces and correlation processing, etc., tailored for detection of the correct signals. Further, receiving the illumination signals from the at least two different access points 22 in the set of access points 22 comprises, in an example scenario, receiving reflected illumination signals 22 corresponding to two or more access points 22 in the set of access points 22, and estimating a position of an object based on the reflected illumination signals.

The configuration information comprises assistance information that, for example, at least indicates positions of respective access points 22 in the set of access points 22. Position indications may be absolute or relative to the UE 12. The assistance information may further indicate one or more transmission parameters of the illumination signals, including any one or more of signal identifiers, signal codes, signal frequencies, signal timing, or beamforming configuration information associated with beamformed transmission of the illumination signals. Note that the configuration information may be received as broadcasted information or via dedicated UE-specific signaling or as a mix of broadcasted and dedicated signaling. For example, the network 10 may broadcast configuration information indicating default or standard multi-static radar operation performed by the network 10 periodically or otherwise without need for specific requests from UEs 12. However, responsive to receiving a request from a UE 12 that indicates more sophisticated radar capabilities or needs, the network 10 may determine a multi-static radar configuration that is tailored for the UE 12 and is to be used temporarily for the UE 12 responsive to the request, and it may send that configuration information via dedicated signaling.

Thus, in one or more embodiments of the method 1100, the method 1100 includes an antecedent step of transmit (Block 1102) a request to a first access point 22 of the network 10, with the first access point 22 acting as a serving access point for the UE 12 and the request requesting activation of multi-static radar operation by the network 10. The UE 12 then receives the configuration information from the serving access point 22 in response to the request.

The method 1100 includes, for example, the UE 12 configuring multi-static radar processing at the UE 12, based on one or more of the configuration information, radar performance requirements known at the UE, and radar operation preferences defined at the UE 12. Configuring the multi-static radar processing at the UE 12 comprises configuring the UE for any one of: time-domain radar operation, spatial-domain radar operation, or a combination of time-domain and spatial-domain radar operations.

The method 1100 in one or more embodiments further includes evaluating the multi-static radar configuration indicated in the configuration information in view of radar performance requirements defined at the UE 12, and determining, based on the evaluation, whether to request additional radar support or re-configured radar illumination from the network 10.

Further in the context of the method 1100, the UE 12 may configure reception beamforming by the UE 12 for reception of the illumination signals, according to the configuration information. The reception beamforming performed by the UE 12 is any one of: analog beamforming, or digital beamforming, or a combination of analog and digital beamforming.

Still further, in at least one embodiment, the method 1100 includes the UE 12 using an Inertial Measurement Unit (IMU) of the UE 12 to estimate relative locations of the UE 12 with respect to receiving different ones of the illumination signals at different times. See the example IMU 128 depicted in FIG. 6.

According to the method 1100, in one or more embodiments, the UE 12 provides radar-detection feedback to the network 10, based on performing radar detection according to the illumination signals received by the UE 12. For example, the UE 12 provides radar-signal measurements as feedback, or processing results or quality indicators based thereon as feedback, with such information enabling adaptation of the involved multi-static radar configuration, e.g., to improve the accuracy or precision of radar-sensing operations by the UE 12.

In at least one embodiment, the method 1100 includes, for illumination-signal reception, the UE 12 using a correlation time that is shorter than a radar pulse length used for the illumination signals, and for each received illumination signal, non-coherently combining correlation results obtained from two or more of the correlation times. Further, in one or more embodiments, the illumination signals transmitted according to a given multi-static radar configuration and correspondingly received by a UE 12 include illumination signals in two or more frequency bands, and the method 1100 includes the UE 12 performing radar correlation between respective ones of the two or more frequency bands.

A UE 12 according to one or more embodiments disclosed herein is configured for operation with a network 10, in that the UE 12 has communication and processing circuitry operative for communicating with or through the network 10. More particularly, the UE 12 includes radio transceiver circuitry, such as the transmitter and receiver circuitries 112 and 114 shown in FIG. 6 and includes processing circuitry 120 that is configured to carry out the method 1100 according to any of the various embodiments of that method described herein.

The processing circuitry 120 of the example UE 12 is, therefore, configured to receive, via the radio transceiver circuitry, configuration information indicating a multi-static radar configuration for illumination of a target region 52 of the network 10 via the transmission of illumination signals by a set of access points 22 of the network 10. Each access point acts as a respective radar transmitter in the multi-static radar configuration and the UE 12 acts as a radar receiver in the multi-static radar configuration. Further, the processing circuitry 120 is configured to receive, via the radio transceiver circuitry, the illumination signals from at least two different access points 22 in the set of access points 22, according to the configuration information, and perform at least one of object detection or self-positioning, based on the received illumination signals.

In at least one embodiment, the processing circuitry 120 is configured to perform object detection, based on receiving the illumination signals from two or more of the access points 22 in the set of access points 22 as reflected illumination signals, and estimating a position of an object based on the reflected illumination signals. Here, and elsewhere, references to two or more access points 22 may be understood as meaning two or more TRPs having some geographical separation between them, even if the two or more TRPs are supported by the same central processing unit—see FIG. 10 for a corresponding example, where each RRU 102-1 and 102-2 may be considered, at least for purposes of transmission diversity, to be a different access point 22.

FIG. 13 illustrates an embodiment of a UE 12 comprising a plurality of processing units or modules that are configured to cause the UE 12 to carry out some or all of the processing operations or functions described for the method 1100 or more generally attributed to UE-side operations for support of multi-static radar transmissions. The processing modules are comprised or otherwise implemented via physical processing circuitry but may be instantiated as virtualized functions, depending on the nature of the UE 12.

The depicted processing modules include a communicating module 140, e.g., for transmitting requests to the network 10 requesting multi-static radar operation by the network 10, or for receiving multi-static radar configuration information, illumination signals, and for transmitting or receiving communication signals, etc.

Further included is a performing module 142 that is configured to perform self-positioning processing or object-detection processing, based on receiving illumination signals from two or more access points 22 that are participating in multi-static radar transmissions. Here, “receive” means receiving the illumination signals via LoS paths, non-LoS paths (e.g., as reflections), or a mix of LoS and non-LoS paths. Still further, the modules include a feedback module 144 that is present in one or more embodiments of the UE 12 and is configured to generate the above-described radar-sensing feedback to the network 10.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1: A method of operation in a wireless communication network, the method comprising:
transmitting configuration information for a User Equipment (UE) from a network node in the wireless communication network, wherein the configuration information indicates a multi-static radar configuration in which the UE acts as a radar receiver and a set of access points in the wireless communication network act as radar transmitters, transmitting respective illumination signals for illumination of a target region.

2: The method according to claim 1, wherein the configuration information comprises assistance information for receiving the illumination signals at the UE, the assistance information at least indicating positions of respective access points in the set of access points.

3: The method according to claim 2, wherein the assistance information further indicates one or more transmission parameters of the illumination signals.

4: The method according to claim 1, wherein the network node is an access point of the wireless communication network that is acting as a serving access point with respect to the UE.

5: The method according to claim 4, further comprising, at the serving access point, receiving a request from the UE for activation of multi-static radar operations, and, responsive to the request, determining or obtaining the multi-static radar configuration and transmitting the configuration information to the UE.

6: The method according to claim 4, further comprising, at the serving access point, exchanging signaling with at least one additional access point, to establish the multi-static radar configuration.

7: The method according to claim 1, further comprising determining the multi-static radar configuration at least in part by identifying access points in the wireless communication network that are associated with the target region.

8: The method according to claim 1, wherein the configuration information comprises assistance information indicative of the locations of respective access points in the set of access points, and wherein the assistance information further indicates one or more transmission parameters of the illumination signals, including any one or more of signal identifiers, signal bandwidth, signal codes, signal frequencies, signal timing, or beamforming configuration information associated with beamformed transmission of the illumination signals.

9: The method according to claim 1, wherein the illumination signals are communication reference signals used by the wireless communication network.

10: The method according to claim 1, wherein, with respect to any one of the access points in the set of access points, the method further comprises transmitting one or more respective ones of the illumination signals, according to the multi-static radar configuration.

11: The method according to claim 10, wherein transmitting the one or more respective ones of the illumination signals comprises performing one or more beamformed transmissions directed towards all or part of the target region.

12: The method according to claim 1, further comprising determining the multi-static radar configuration, including determining whether the set of access points uses concurrent or non-concurrent transmissions.

13: The method according to claim 1, further comprising determining the multi-static radar configuration to include in the set of access points only access points that have Line-of-Sight (LoS) illumination towards at least a portion of the target region.

14: The method according to claim 1, further comprising determining the multi-static radar configuration, including determining whether to use narrowband illumination signals or wideband illumination signals or both narrowband and wideband illumination signals based on at least one of: multi-static radar capabilities indicated by the UE or multi-static radar requirements indicated by the UE.

15: The method according to claim 1, wherein the UE is one among two or more UEs in the target region or in one or more neighboring service areas that request multi-static radar operation, and wherein the method further comprises determining the multi-static radar configuration in joint consideration of multi-static radar needs or capabilities respectively indicated by the two or more UEs.

16: The method according to claim 1, wherein transmitting the configuration information to the UE comprises broadcasting all or parts of the configuration information for reception by the UE.

17: The method according to claim 1, wherein the network node is a serving access point of the UE and transmitting the configuration information comprises performing a radio transmission of the configuration information, or wherein the network node is not the serving access point of the UE and transmitting the configuration information comprises sending the configuration information to the serving access node, for radio transmission by the serving access node.

18: A method performed by a User Equipment (UE) configured for operation with a wireless communication network, the method comprising:
receiving configuration information indicating a multi-static radar configuration for illumination of a target region of the wireless communication network via the transmission of illumination signals by a set of access points of the wireless communication network, each access point acting as a respective radar transmitter in the multi-static radar configuration and the UE acting as a radar receiver in the multi-static radar configuration;
receiving the illumination signals from at least two different access points in the set of access points, according to the configuration information; and
performing object detection based on the received illumination signals.

19: The method according to claim 18, wherein receiving the illumination signals from the at least two different access points in the set of access points comprises receiving reflected illumination signals corresponding to two or more access points in the set of access points and estimating a position of an object based on the reflected illumination signals.

20: The method according to claim 18, wherein the configuration information comprises assistance information, the assistance information at least indicating positions of respective access points in the set of access points.

21: The method according to claim 20, wherein the assistance information further indicates one or more transmission parameters of the illumination signals, including any one or more of signal identifiers, signal bandwidth, signal codes, signal frequencies, signal timing, or beamforming configuration information associated with beamformed transmission of the illumination signals.

22: The method according to claim 18, further comprising transmitting a request to a first access point of the wireless communication network, the first access point acting as a serving access point for the UE and the request requesting activation of multi-static radar operation by the wireless communication network, and wherein receiving the configuration information comprises the UE receiving the configuration information from the serving access node in response to the request.

23: The method according to claim 18, wherein receiving the configuration information comprises receiving all or parts of the configuration information as broadcasted information.

24: The method according to claim 18, further comprising configuring multi-static radar processing at the UE based on one or more of the configuration information, radar performance requirements known at the UE, and radar operation preferences defined at the UE.

25: The method according to claim 24, wherein configuring the multi-static radar processing at the UE comprises configuring the UE for any one of: time-domain radar operation, spatial-domain radar operation, or a combination of time-domain and spatial-domain radar operations.

26: The method according to claim 18, further comprising evaluating the multi-static radar configuration indicated in the configuration information in view of radar performance requirements defined at the UE, and determining, based on the evaluation, whether to request additional radar support or re-configured radar illumination from the wireless communications network.

27: The method according to claim 18, further comprising configuring reception beamforming by the UE for reception of the illumination signals, according to the configuration information, the reception beamforming being any one of: analog beamforming, or digital beamforming, or a combination of analog and digital beamforming.

28: The method according to claim 18, further comprising using an Inertial Measurement Unit (IMU) of the UE to estimate relative locations of the UE with respect to receiving different ones of the illumination signals at different times.

29: The method according to claim 18, further comprising providing radar-detection feedback to the wireless communication network, based on performing radar detection according to the illumination signals received by the UE.

30: The method according to claim 18, further comprising, for illumination-signal reception, using a correlation time that is shorter than a radar pulse length used for the illumination signals, and for each received illumination signal, non-coherently combining correlation results obtained from two or more of the correlation times.

31: The method according to claim 18, wherein the illumination signals include illumination signals in two or more frequency bands, and wherein the method further comprises the UE combining radar measurement results from two or more frequency bands.

32: A User Equipment (UE) configured for operation with a wireless communication network, the UE comprising:
radio transceiver circuitry; and
processing circuitry configured to:
receive, via the radio transceiver circuitry, configuration information indicating a multi-static radar configuration for illumination of a target region of the wireless communication network via the transmission of illumination signals by a set of access points of the wireless communication network, each access point acting as a respective radar transmitter in the multi-static radar configuration and the UE acting as a radar receiver in the multi-static radar configuration;
receive, via the radio transceiver circuitry, the illumination signals from at least two different access points in the set of access points, according to the configuration information; and
perform object detection based on the received illumination signals.

33: The UE according to claim 32, wherein the processing circuitry is configured to perform object detection, based on receiving the illumination signals from two or more of the access points in the set of access points as reflected illumination signals, and estimating a position of an object based on the reflected illumination signals.

34: A network node configured for operation in a wireless communication network, the network node comprising:
communication interface circuitry; and
processing circuitry configured to transmit, via the communication interface circuitry configuration information for a UE, wherein the configuration information indicates a multi-static radar configuration in which the UE acts a radar receiver and a set of access points in the wireless communication network act as radar transmitters, transmitting respective illumination signals for illumination of a target region.

35: The network node according to claim 34, wherein the network node comprises an access point of the wireless communication network that is acting as a serving access point with respect to the UE.
